(19) United States
(12) Patent Application Publication
(10) Pub. No.: US 2010/0150249 A1
(43) Pub. Date: Jun. 17, 2010

(54) STAGGERCASTING WITH NO CHANNEL CHANGE DELAY

(76) Inventors: David Anthony Campana, Princeton, NJ (US); Alan Jay Stein, Princeton, NJ (US); Kumar Ramaswamy, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/733,226

(22) PCT Filed: Aug. 26, 2008
(86) PCT No.: PCT/US2008/010117

§ 371 Date: Feb. 16, 2010

Related U.S. Application Data
(60) Provisional application No. 60/966,431, filed on Aug. 28, 2007.

(51) Int. Cl. H04N 7/26

(52) U.S. Cl. 375/240.25; 375/240.27; 375/E07.078

(57) ABSTRACT

An Advanced Television Systems Committee Digital Television (ATSC DTV) mobile, or handheld, device comprises a receiver for receiving a signal that includes a mobile DTV channel, which is transmitted in StaggerCast form comprising an FEC (Forward Error Correcting) stream and an encoded stream delayed in time from the FEC stream for conveying program content. The receiver decodes the received encoded stream for providing the program content and, if errors are detected in the received encoded stream, uses the received FEC stream to attempt to correct the errors. However, when the uses changes programs, or channels, to a different StaggerCast stream, the receiver decodes a received encoded stream of the different StaggerCast stream for providing the new program content even though for an initial period of time error correction by the receiver is severely limited.

### CROSS-REFERENCE TO RELATED APPLICATIONS

This application claims the benefit of U.S. Provisional Application No. 60/966,431, filed Aug. 28, 2007.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

The ATSC DTV (Advanced Television Systems Committee Digital Television) system (e.g., see, United States Advanced Television Systems Committee, “ATSC Digital Television Standard”, Document A/53, Sep. 16, 1995 and “Guide to the Use of the ATSC Digital Television Standard”, Document A/54, Oct. 4, 1995) offers about 19 Mbits/sec (millions of bits per second) for transmission of an MPEG2-compressed HDTV (high definition TV) signal (MPEG2 refers to Moving Picture Expert Group (MPEG)-2 Systems Standard (ISO/IEC 13818-1)). As such, around four to six TV channels can be supported in a single physical transmission channel (PTC) without congestion. Additionally, excess bandwidth remains within this transport stream to provide for additional services. In fact, due to improvements in both MPEG2 encoding and the introduction of advanced codec (coder/decoder) technology (such as H.264 or VC1), even more additional spare capacity is becoming available in a PTC.

However, the ATSC DTV system was designed for fixed reception and performs poorly in a mobile environment due to fading and Doppler effects that can easily cause signal loss for a period of a second or more at the receiver. In this regard, there has been strong interest in developing an ATSC DTV system for mobile and handheld (M/H) devices while maintaining backward compatibility with the existing ATSC DTV system.

One way to improve performance in a mobile environment is to use time diversity techniques combined with forward error correction (FEC). Some examples of forward error correction are block codes (e.g., Reed-Solomon, BCH), convolution codes, low-parity check codes (LDPC) and turbo codes. Time interleaving can be accomplished either using block or convolution interleaving techniques. FEC, when used in combination with interleavers, vastly improves communication performance over fading channels. Unfortunately, these systems generally incur a time delay that is proportional to the time diversity. As such, an unfortunate side effect of such time diversity techniques in the context of a mobile TV system is that a user would see this delay in the form of long channel change times when switching channels, which may be highly objectionable to the user. As such, the designer of a mobile TV system is forced to tradeoff fast channel change against time diversity for and fade protection. Increasing the performance in one area generally means a decrease in the performance in another area.

### SUMMARY OF THE INVENTION

However, we have realized that both time diversitý for fade protection and rapid channel change can be achieved if a set of requirements is imposed on both the broadcast and terminal device. In particular, StaggerCasting (a form of time diversity protection) is used in accordance with the principles of the invention to provide protection to a wireless transmission stream from fades without incurring any channel change delay.

In accordance with the principles of the invention, a receiver receives a channel comprising at least one encoded stream and an error correcting stream, wherein the encoded stream is staggered with respect to the error correcting stream; decodes the received encoded stream for providing content; corrects the received encoded stream using the received error correcting stream upon detecting errors in the received encoded stream; and when a different channel is selected, decodes a received encoded stream of the different channel for providing content even though for an initial period of time equal to a time delay errors in the received encoded stream of the different channel are not correctable by the received error correcting stream of the different channel; wherein the encoded stream of the different channel is delayed with respect to the error correcting stream of the different channel by the time delay.

In an illustrative embodiment of the invention, an Advanced Television Systems Committee Digital Television (ATSC DTV) mobile, or handheld, device comprises a receiver for receiving a digital multiplex that includes a mobile DTV channel, which is transmitted in StaggerCast form. In particular, the receiver receives a StaggerCast signal comprising an encoded stream for conveying the content for a selected program, e.g., the video and audio, and an error correcting stream, e.g., FEC blocks. With respect to the StaggerCasting, the encoded stream is delayed with respect to the error correcting stream by a time delay. Illustratively, all StaggerCast signals have the same time delay. The receiver decodes the received encoded stream for providing content for the selected program and, if errors are detected in the received encoded stream, uses the received error correcting stream to attempt to correct the errors. However, when the uses changes programs, or channels, to a different StaggerCast stream, the receiver decodes a received encoded stream of the different StaggerCast stream for providing content even though for an initial period of time equal to the time delay errors in the received encoded stream of the different StaggerCast stream are not correctable by the received error correcting stream of the different StaggerCast stream.

In view of the above, and as will be apparent from reading the detailed description, other embodiments and features are also possible and fall within the principles of the invention.

### BRIEF DESCRIPTION OF THE DRAWINGS

FIG. 1 illustrates a StaggerCast stream in accordance with the principles of the invention;

FIG. 2 shows an illustrative embodiment of a transmitter in accordance with the principles of the invention;

FIG. 3 shows an illustrative multiplexed stream formed in the transmitter of FIG. 2;

FIG. 4 shows an illustrative flow chart for use in a transmitter in accordance with the principles of the invention;

FIG. 5 shows an illustrative embodiment of a device in accordance with the principles of the invention;

FIG. 6 shows an illustrative embodiment of a receiver in accordance with the principles of the invention;

FIG. 7 shows an illustrative flow chart for use in a receiver in accordance with the principles of the invention; and

FIG. 8 shows another illustrative StaggerCast in accordance with the principles of the invention.

### DETAILED DESCRIPTION

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for television (TV) standards such as NTSC (National Television Systems Committee), PAL (Phase Alternation Lines), SECAM (SEquential Couleur Avec Memoire), ATSC (Advanced Television Systems Committee), Digital Video Broadcasting (DVB), Digital Video Broadcasting-Terrestrial (DVB-T) (e.g., see ETSI EN 300 744 V1.4.1 (2001-01), Digital Video Broadcasting (DVB); Framing structure, channel coding and modulation for digital terrestrial television, DVB-H and the Chinese Digital Television System (GB) 20600-2006 (Digital Multimedia Broadcasting—Terrestrial/Handheld (DMB-T/H)) is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as the File Delivery over Unidirectional Transport (FLUTE) protocol, Asynchronous Layered Coding (ALC) protocol, Internet protocol (IP) and Internet Protocol Encapsulator (IPE), is assumed and not described herein. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

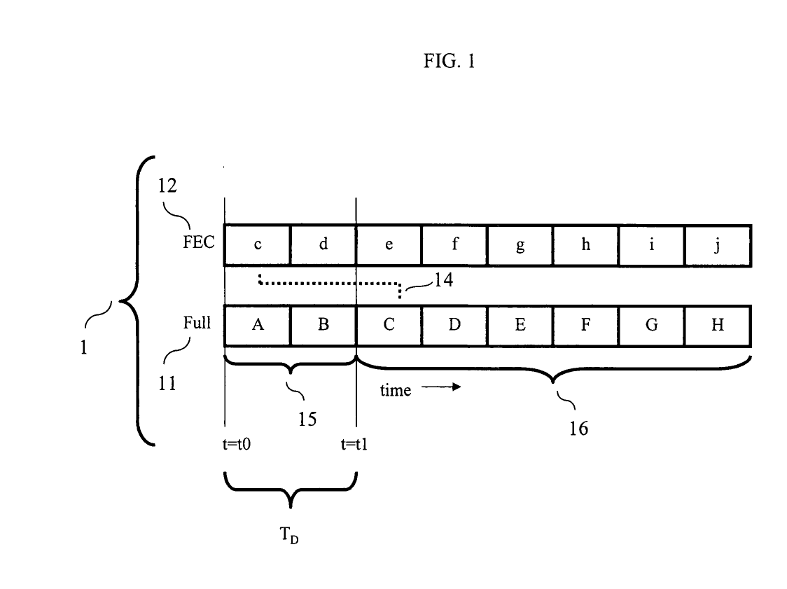

FIG. 1 illustrates a StaggerCast broadcast stream, 1, in accordance with the principles of the invention in the context of a mobile DTV system. StaggerCast broadcast stream 1 comprises a complete, or full, media stream 11 and a separate FEC stream 12. The full media stream is also referred to herein as the base stream or encoded stream, which conveys the media, or content (e.g., video and/or audio) for TV programs. It should be noted that the full stream 11 does not convey FEC data within the full stream. As such, a receiver decoding only this full stream 11 would be capable of rendering the media, or content (e.g., video and/or audio) for display to a user but would have low tolerance to channel errors. As such, full stream 11 comprises a stream of blocks labeled A to H (in upper case) sent without FEC protection. However, the corresponding FEC data is provided by FEC stream 12, which comprises a sequence of FEC blocks (or FEC data) labeled c to j (in lower case). As illustrated in FIG. 1, the FEC block labeled “c” is the FEC data that can be used to correct for errors in the reception of block “C” (as represented by dotted line 14). As can be observed from FIG. 1, full stream 11 is delayed with respect to FEC stream 12 by a time delay T_{D}, where T_{D}=t1−t0, i.e., full stream 11 and FEC stream 12 are staggered in time.

To see how a receiver enjoys the benefits of redundancy without inducing additional delay in changing channels in accordance with the principles of the invention refer again to FIG. 1. At a time, t=t0, the receiver starts to receive StaggerCast broadcast stream 1. However, because of the StaggerCasting time delay, T_{D}, the FEC blocks “c” and “d” initially received during this time T_{D} do not correspond to the data “A” and “B” conveyed in full stream 11. Since the receiver does not have the FEC data for “A” or “B”, the receiver cannot correct for errors until after the time delay, T_{D}, starting with block “C”. The data that has no protection for the period of time T_{D} is represented by label 15 in FIG. 1. Thus, for the receiver to provide complete Quality of Service (QoS) to a user, the receiver must wait for the time delay T_{D} before processing full stream 11. Unfortunately, this introduces a delay in changing channels. However, and in accordance with the principles of the invention, the receiver starts playing the full stream 11 starting with data “A” and immediately showing content to a user. Thus, the user incurs no channel change delay in switching programs (or channels) as this data can be rendered as soon as it is available even though there is no error protection for this data. However, after the time delay T_{D}, i.e., at time t=t1, the receiver has not only the base data of full stream 11, but also the corresponding FEC data from FEC stream 12. Therefore, for the data starting at block “C” for full stream 11 represented by the label 16, there is all the benefits of redundancy while maintaining low delay.

In the above-described example, the time diversity is represented by the time delay T_{D}. In accordance with the principles of the invention, after a channel change the receiver processes data without the benefit of time diverse FEC for this same interval of time. The time delay T_{D} can be tuned in order to provide an appropriate trade-off. While it is assumed that all StaggerCast streams have the same time delay, the inventive concept is not so limited and the time delays can vary between different StaggerCast streams. For example, one StaggerCast stream may have a first time delay, T_{D1}, while a second StaggerCast stream may have a different second time delay T_{D2}. In such cases, it is assumed that the receiver receives associated program and system information indicating the appropriate time delay for a received StaggerCast signal. In fact, the delay on the same channel, T_{D}, itself may not be fixed and can vary. In the case of a varying delay, the value can be bounded, e.g., 0<T_{D}≦T_{Dmax}. A variable delay might be required if variable bit rate (VBR) content is conveyed over a constant bit rate (CBR) channel, or CBR content is conveyed over a VBR channel. In this case a sequence number found in an RTP (Real-Time Protocol) specific field can be used to by the receiver for re-aligning, or re-synchronizing, the FEC stream and the base stream in the receiver.

Thus, and in accordance with the principles of the invention, a receiver receives a channel comprising at least one encoded stream and an error correcting stream, wherein the encoded stream is staggered with respect to the error correcting stream; decodes the received encoded stream for providing content; corrects the received encoded stream using the received error correcting stream upon detecting errors in the received encoded stream; and when a different channel is selected, decodes a received encoded stream of the different channel for providing content even though for an initial period of time equal to a time delay errors in the received encoded stream of the different channel are not correctable by the received error correcting stream of the different channel; wherein the encoded stream of the different channel is delayed with respect to the error correcting stream of the different channel by the time delay.

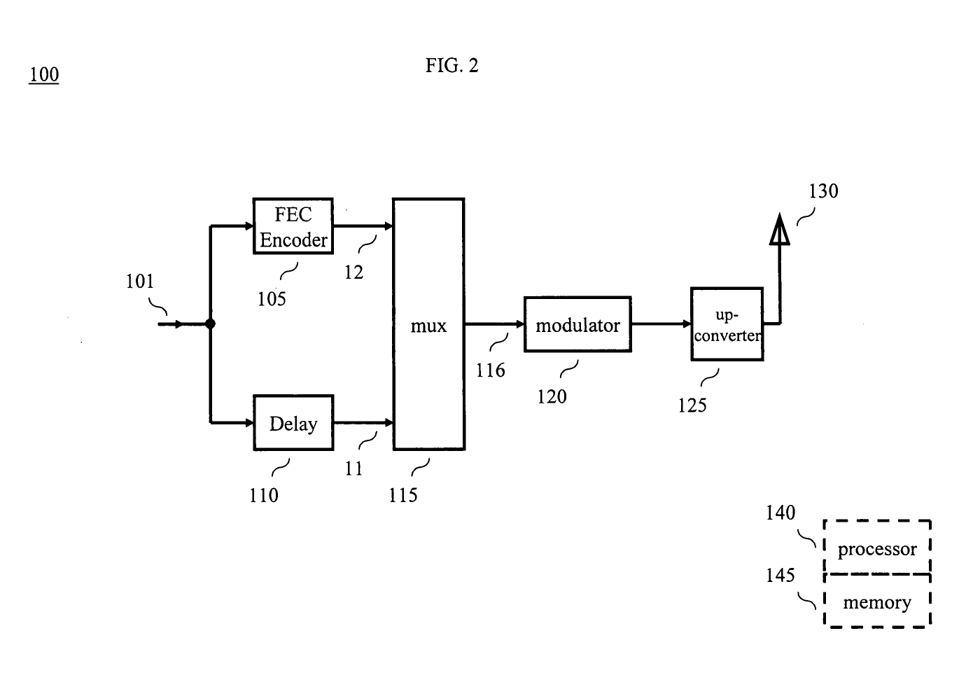

Turning now to FIG. 2, an illustrative transmitter 100 in accordance with the principles of the invention is shown. Only those portions of transmitter 100 relevant to the inventive concept are shown. Transmitter 100 is a processor-based system and includes one, or more, processors and associated memory as represented by processor 140 and memory 145 shown in the form of dashed boxes in FIG. 2. In this context, computer programs, or software, are stored in memory 145 for execution by processor 140 and, e.g., implement FEC encoder 105. Processor 140 is representative of one, or more, stored-program control processors and these do not have to be dedicated to the transmitter function, e.g., processor 140 may also control other functions of the transmitter 100. Memory 145 is representative of any storage device, e.g., random-access memory (RAM), read-only memory (ROM), etc.; may be internal and/or external to the transmitter; and is volatile and/or non-volatile as necessary.

The elements shown in FIG. 2 comprise an FEC encoder 105, delay buffer 110, multiplexer (mux) 115, modulator 120, upconverter 125 and antenna 130. A full stream 101 conveying encoded content (e.g., MPEG-2 encoded video and audio) in packet form is applied to FEC encoder 105 and delay buffer 110. The latter delays full stream 101 by time delay T_{D} to provide full stream 11. FEC encoder 105 is illustratively a simple rate ½ FEC repetition code that repeats every symbol. In general form, an FEC encoder receives k symbols and provides a block of N symbols, where N−k of the symbols are redundant symbols. An FEC code has the property that if any k of the N symbols are received, then it is possible to reconstruct the original k symbols. FEC encoder 105 receives full stream 101 and provides FEC stream 12.

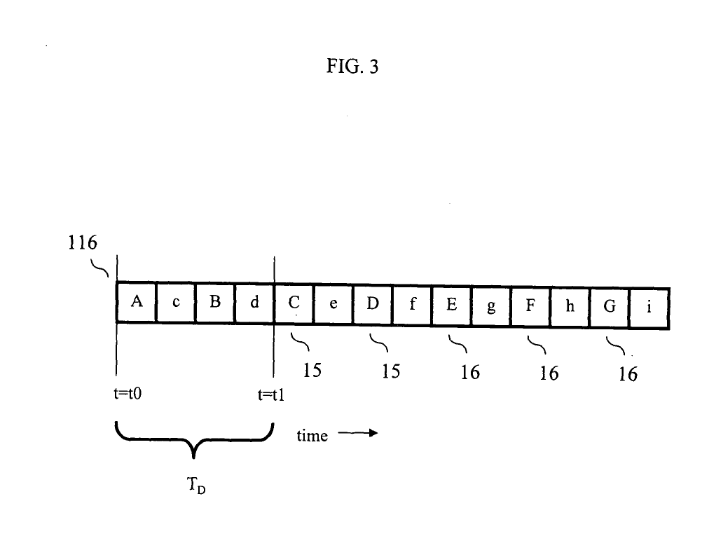

Both full stream 11 and FEC stream 12 are applied to mux 115, which multiplexes the two logical channels (full stream 11 and FEC stream 12) to provide a multiplexed stream 116 for application to modulator 120. An example of multiplexed stream 116 is shown in FIG. 3. Returning to FIG. 2, modulator 120 modulates multiplexed stream 116 and the resulting signal is up-converted to a radio frequency (RF) TV channel via up-converter 125 for transmission of the mobile DTV signal via antenna 130.

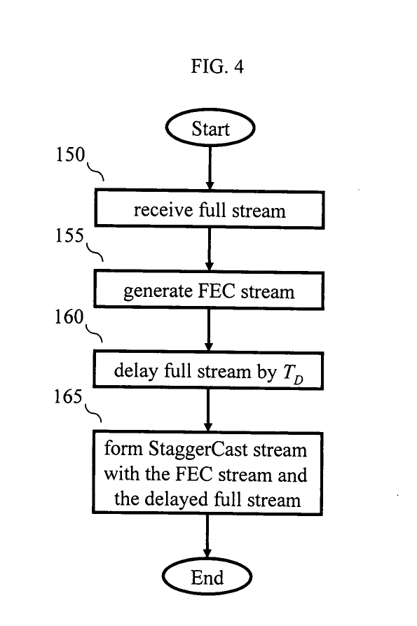

Referring now to FIG. 4, an illustrative flow chart for use in transmitter 100 in accordance with the principles of the invention is shown. In step 150, transmitter 100 receives a full stream for broadcast transmission. In step 155, transmitter 100 forms an FEC stream from the full stream. In step 160, transmitter 100 delays the full stream by a time delay, T_{D}. Finally, in step 165, transmitter 100 forms a StaggerCast stream for transmission, where the StaggerCast stream comprises the FEC stream and the delayed full stream.

It should be noted that in general, it is preferable not to use a time interleaver with significant delay for the full stream 11. However, if even better fading performance is desired, time interleaving can be used on the FEC stream 12. This does not add to the overall channel delay experienced by the receiver. In addition, although the example above was illustrated with a simple rate ½ FEC repetition code, a much more sophisticated code could be used. For example, a long code could be used to provide the ability to recreate even a completely lost base datagram. A simple example of this is a ¾ FEC code that operates on 2 blocks from the above diagram shown in FIG. 1. For example, even if both blocks C and D from full stream 11 are lost, using this FEC code, FEC blocks c+d can be used to recreate these missing blocks. In order to achieve this, the t1−t0 spacing has to be increased by 1 block. Again, like before, this increases the amount of time after a channel change during which the system operates without error protection, but does not increase any channel change delay experienced by a user.

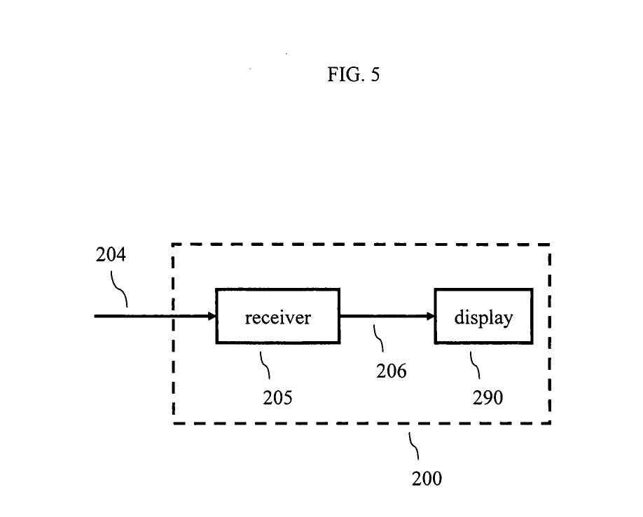

Referring now to FIG. 5, an illustrative embodiment of a device 200 in accordance with the principles of the invention is shown. Device 200 is representative of any processor-based platform, whether hand-held, mobile or stationary. For example, a PC, a server, a set-top box, a personal digital assistant (PDA), a cellular telephone, a mobile digital television (DTV), a DTV, etc. In this regard, device 200 includes one, or more, processors with associated memory (not shown). Device 200 includes a receiver 205 and a display 290. Receiver 205 receives a broadcast signal 204 (e.g., via an antenna (not shown)) for processing to recover therefrom, e.g., a video signal 206 for application to display 290 for viewing video content thereon.

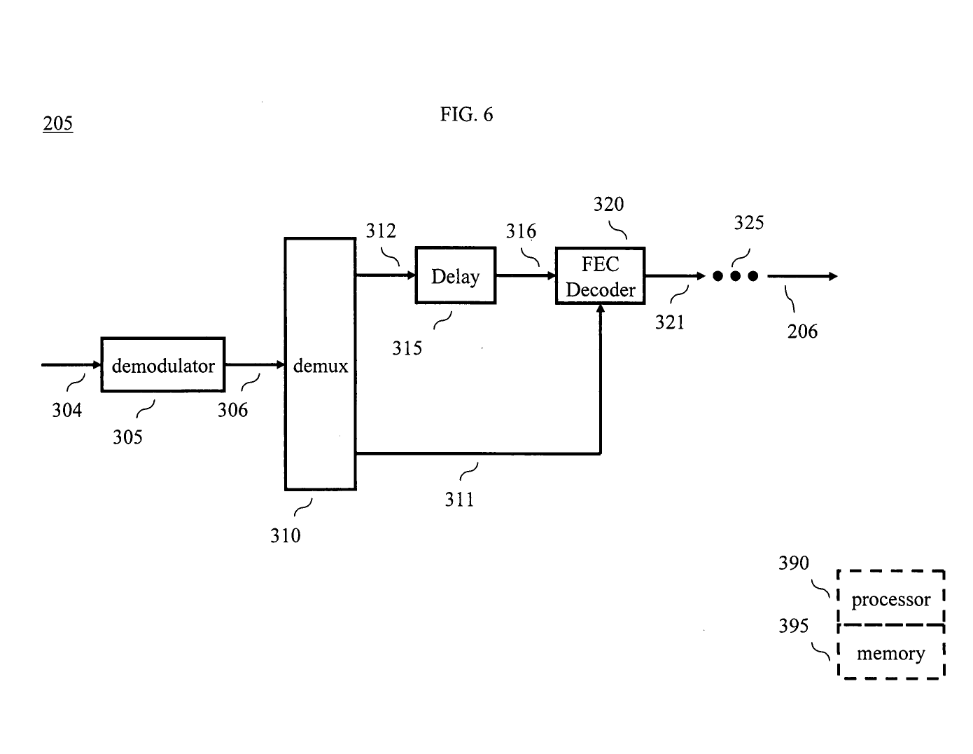

Turning now to receiver 205, an illustrative portion of receiver 205 in accordance with the principles of the invention is shown in FIG. 6. Only those portions relevant to the inventive concept are shown. Receiver 205 is a processor-based system and includes one, or more, processors and associated memory as represented by processor 390 and memory 395 shown in the form of dashed boxes in FIG. 6. In this context, computer programs, or software, are stored in memory 395 for execution by processor 390 and, e.g., implement FEC decoder 320. Processor 390 is representative of one, or more, stored-program control processors and these do not have to be dedicated to the receiver function, e.g., processor 390 may also control other functions of receiver 205. Memory 395 is representative of any storage device, e.g., random-access memory (RAM), read-only memory (ROM), etc.; may be internal and/or external to receiver 205; and is volatile and/or non-volatile as necessary.

Receiver 205 comprises demodulator 305, demultiplexer (demux) 310, delay buffer 315 and FEC decoder 320. Only those portions relevant to the inventive concept are shown. As noted above, receiver 205 receives a broadcast signal 204 (e.g., via an antenna (not shown)) for processing. Broadcast signal 204 is downconverted by front-end processing (not shown) to provide received signal 304. The latter is demodulated by demodulator 305, which provides demodulated signal 306 (a stream of symbols) to demux 310. Demux 310 performs the inverse function of mux 115 of transmitter 100 and separates out the full stream from the FEC stream. In particular, demux 310 provides full stream 311, which corresponds to the received version of full stream 11, and also provides FEC stream 312, which corresponds to the received version of FEC stream 12. The latter is delayed in time by delay buffer 315 to provide delayed FEC stream 316. Delay buffer 315 provides a corresponding time delay of T_{D} to realign in time the full stream with the FEC stream. FEC decoder 320 receives both the delayed FEC stream 31 and the full stream 311 for providing output signal 321. The latter is processed by other circuitry (not shown) of receiver 205 as represented by ellipses 325 to recover therefrom, e.g., the video signal 206.

Referring briefly back to FIG. 1, at receiver startup, or just after selecting a channel, the delay buffer 315 in receiver 205 is flushed, i.e., empty, for the period of time equal to T_{D}. As such, in this initial period after a channel change, FEC decoder 320 does not have any FEC data for the data of interest, e.g., blocks “A” and “B”, so it merely passes through the unprotected full stream 311 to its output, i.e., as output signal 321. As a result, if a channel fade occurs immediately after a channel change during this time interval, T_{D}, the subsequently decoded and rendered video may show artifacts during this period. In the worst case scenario, the full stream is not robust enough to even decode until the FEC channel is available at time t1. In this case, the user will perceive the delay in switching channels. However, this should be infrequent and most of the time the user will experience no channel change delay in accordance with the principles of the invention.

After the time delay, T_{D}, FEC decoder 320 can attempt to correct any detected errors in full stream 311 by using the corresponding error correcting data in FEC stream 316 in providing output signal 321.

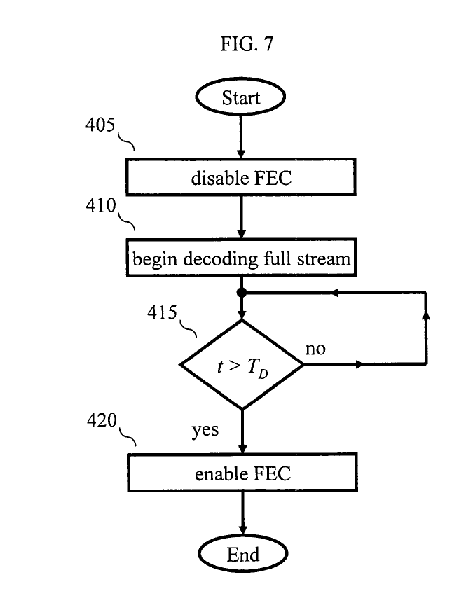

Referring now to FIG. 7, an illustrative flow chart for use in receiver 205 in accordance with the principles of the invention is shown. Upon power up or selection of a channel for reception, receiver 205 disables FEC in step 405 and begins decoding any received full stream in step 410. In step 415, while decoding the full stream, receiver 205 checks when the StaggerCasting time delay, T_{D}, has passed (e.g., via an interrupt from a timer). Once the StaggerCasting time delay, T_{D}, has passed, receiver 205 enables FEC in step 420, otherwise, receiver 205 keeps decoding the full stream with FEC protection.

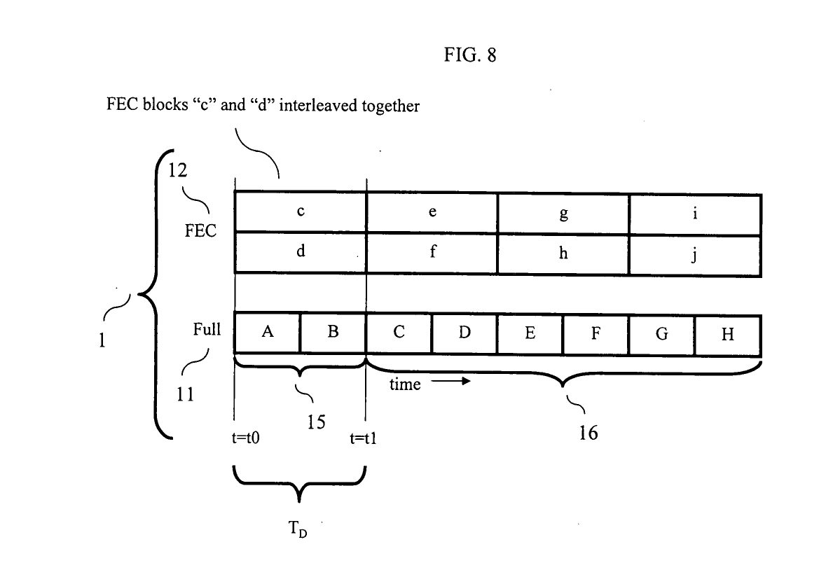

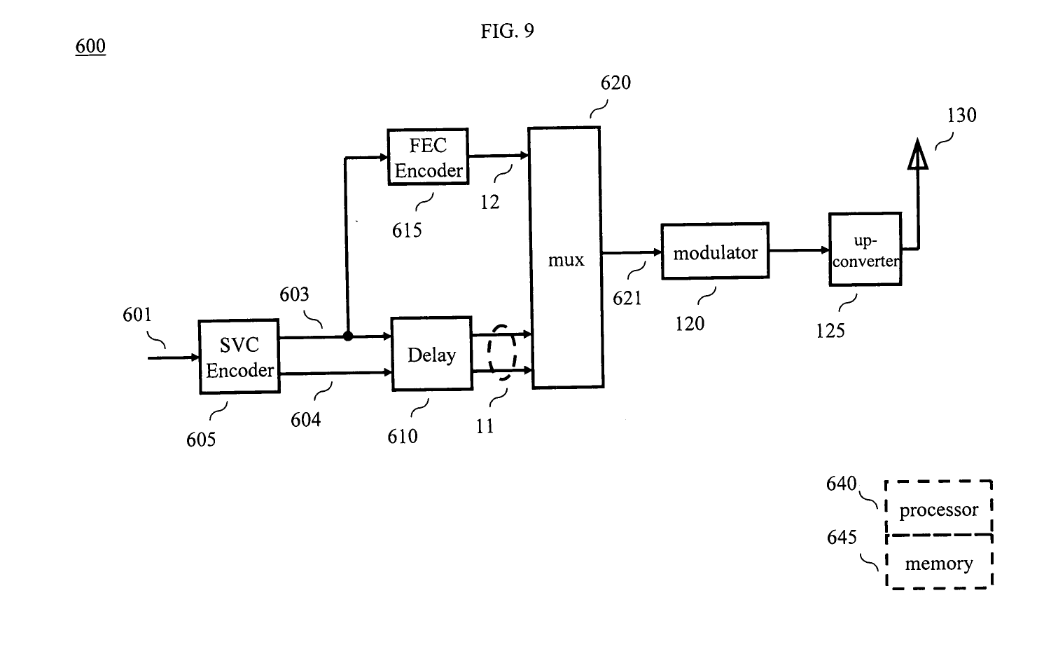

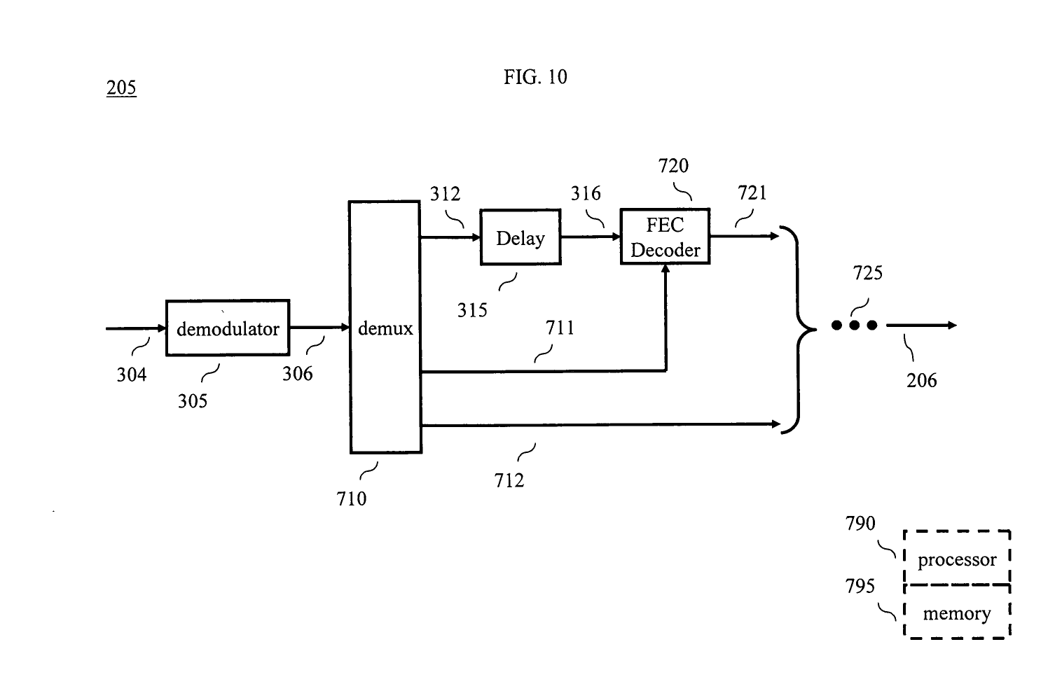

In accordance with the principles of the invention, there are a number of interesting variations. For example, less bits can be dedicated to the FEC encoding and the FEC can be combined with a more powerful code that has the ability to correct for longer blocks to achieve superior performance with no additional bandwidth or delay requirements. One example of this is a block code with the ability to control errors that are distributed over multiple blocks such as a convolutional code, turbo code, LDPC code. Another example of this is interleaving the error correcting stream with a long interleaving delay without incurring additional delay. This is illustrated in FIG. 8. In FIG. 8, pairs of blocks of the FEC stream are interleaved. This is represented in FIG. 8 by block “c” being located above block “d”. As a result of this interleaving, the FEC stream can now withstand fades (loss of signal) that are longer than the duration of a “block”. A logical extension of this process is to use a PRO-MPEG style code for the error correcting stream that organizes the data as a matrix and generates FEC parity of both the row and column data. Again, the delay that this would normally incur is not a problem for changing channels because the error correcting stream is broadcast before the signal.

In addition, SVC (scalable video coding) can be used to encode the full stream. In SVC, there is typically an SVC base layer and at least one SVC enhancement layer. The SVC base layer provides a basic level of video resolution, e.g., standard definition, while any SVC enhancement layers increase the video resolution, e.g., high definition. In the context of this invention, the SVC enhanced layer can be broadcast without any StaggerCasting protection, and StaggerCasting of error correcting data, e.g., FEC data, can be provided only to the SVC base layer. This provides for a fallback video signal to be available with very high reliability without unnecessary increase in the bit rate.

This is further illustrated in accordance with the principles of the invention in transmitter 600 of FIG. 9. Only those portions of transmitter 600 relevant to the inventive concept are shown. Transmitter 600 is a processor-based system and includes one, or more, processors and associated memory as represented by processor 640 and memory 645 shown in the form of dashed boxes in FIG. 9. In this context, computer programs, or software, are stored in memory 645 for execution by processor 640 and, e.g., implement FEC encoder 615. Processor 640 is representative of one, or more, stored-program control processors and these do not have to be dedicated to the transmitter function, e.g., processor 640 may also control other functions of the transmitter 600. Memory 6145 is representative of any storage device, e.g., random-access memory (RAM), read-only memory (ROM), etc.; may be internal and/or external to the transmitter; and is volatile and/or non-volatile as necessary.

The elements shown in FIG. 9 comprise an SVC encoder 606, an FEC encoder 615, delay buffer 610, multiplexer (mux) 620, modulator 120, upconverter 125 and antenna 130. A full stream 601 of content prior to video encoded is applied to SVC encoder 605. The latter provided a base layer stream 603 and at least one enhancement layer stream 604. As can be observed only base layer stream 603 is applied to FEC encoder 615. Both the base layer stream 603 and enhancement layer stream 604 are applied to delay buffer 610 which delays all components (i.e., the base layer and the enhancement layer) of the SVC-encoded signal by time delay T_{D}. The delayed SVC signals are applied to mux 620 as represented by dotted circle 11 (representing, in effect, full stream 11). FEC encoder 615 is illustratively a simple rate ½ FEC repetition code that repeats every symbol, although the inventive concept is not so limited. Mux 620 multiplexes all the logical channels (full stream 11 and FEC stream 12) to provide a multiplexed stream 621 for application to modulator 120. The latter modulates multiplexed stream 621 and the resulting signal is up-converted to a radio frequency (RF) TV channel via up-converter 125 for transmission of the mobile DTV signal via antenna 130. The method shown in FIG. 4 can be modified in a straight forward fashion such that step 155 generates the FEC stream only from the base layer of an SVC encoded signal.

Turning now to receiver 205, an illustrative portion of receiver 205 in accordance with the principles of the invention for use in SVC is shown in FIG. 10. Only those portions relevant to the inventive concept are shown. Receiver 205 is a processor-based system and includes one, or more, processors and associated memory as represented by processor 790 and memory 795 shown in the form of dashed boxes in FIG. 10. In this context, computer programs, or software, are stored in memory 795 for execution by processor 790 and, e.g., implement FEC decoder 720. Processor 790 is representative of one, or more, stored-program control processors and these do not have to be dedicated to the receiver function, e.g., processor 790 may also control other functions of receiver 205. Memory 795 is representative of any storage device, e.g., random-access memory (RAM), read-only memory (ROM), etc.; may be internal and/or external to receiver 205; and is volatile and/or non-volatile as necessary.

Receiver 205 comprises demodulator 305, demultiplexer (demux) 710, delay buffer 315 and FEC decoder 720. Only those portions relevant to the inventive concept are shown. As noted above, receiver 205 receives a broadcast signal 204 (e.g., via an antenna (not shown)) for processing. Broadcast signal 204 is downconverted by front-end processing (not shown) to provide received signal 304. The latter is demodulated by demodulator 305, which provides demodulated signal 306 (a stream of symbols) to demux 710. Demux 710 performs the inverse function of mux 620 of transmitter 600 and separates out the full stream from the FEC stream. In particular, demux 710 provides a full stream, as represented by a received base layer stream 711 and an enhancement layer stream 712, which corresponds to the received version of full stream 11, and also provides FEC stream 312, which corresponds to the received version of FEC stream 12. The latter is delayed in time by delay buffer 315 to provide delayed FEC stream 316. Delay buffer 315 provides a corresponding time delay of T_{D} to realign in time the full stream with the FEC stream. FEC decoder 720 receives both the delayed FEC stream 31 and base layer stream 711 for providing output signal 721. The base layer now represented by output signal 721 and the enhancement layer stream 712 are processed by other circuitry (not shown) of receiver 205 as represented by ellipses 725 to recover therefrom, e.g., the video signal 206.

At receiver startup, or just after selecting a channel, the delay buffer 315 in receiver 205 is flushed, i.e., empty, for the period of time equal to T_{D}. As such, in this initial period after a channel change, FEC decoder 720 does not have any FEC data for protecting the base layer stream, so it merely passes through the unprotected base layer stream 711 to its output, i.e., as output signal 721. After the time delay, T_{D}, FEC decoder 720 can attempt to correct any detected errors in base layer stream 711 by using the corresponding error correcting data in FEC stream 316 in providing output signal 321. The method shown in FIG. 7 is equally applicable for use in receiver 205 of FIG. 10 for receiving an SVC encoded signal.

It should also be noted that inventive concept equally applies to the transmission of audio as the encoded stream. As such, the apparatus and methods described above in accordance with the principles of the invention also apply to compressed audio both non-scalable and scalable for implementing fast channel change. For example, in terms of audio, device 205 of FIG. 10 now receives a scalable coded audio signal and signal 711 is now the base layer stream of the received scalable coded audio signal and signal 712 is the enhancement layer of the received scalable coded audio signal. An example of a scalable audio codec includes an MPEG4-AAC scalable codec.

As described above, and in accordance with the principles of the invention, StaggerCasting is used to provide protection to a wireless transmission stream from fades without incurring any channel change delay. It should be noted that although the inventive concept was described in the context of blocks, e.g., blocks “A”, “B” and “C” of FIG. 1, the invention is not so limited and there is no requirement in practice to break the data into blocks. For example, redundant FEC streams and convolutional codes do not require blocks. Also, the time offset of the StaggerCast stream T_{D} is a selectable parameter. In general, this offset should be large enough to decorrelate the signal quality of the channel between the regular and the StaggerCast stream. In other words, the probability that “a” can not be received should not be closely correlated to the probability that “A” can not be received. This is the notion of time diversity. In general, the greater the value of T_{D}, the greater decorrelation that is achieved, though in practice an offset on the order of several seconds is sufficient. In this context, there are some drawbacks in choosing extremely large time offset values between the error correcting stream and the full stream. First, there is a longer period of unprotected video (unprotected in the sense that no FEC data is available to correct for transmission errors) after a channel change. In general, the length of time of this unprotected video is equal to the StaggerCast offset T_{D}. And, second, greater memory requirements (e.g., a larger delay buffer and possibly processing requirements on the receiver.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor, which executes associated software, e.g., corresponding to one or more of the steps shown in, e.g., FIG. 7, etc. Further, although some of the figures may suggest the elements are bundled together, the inventive concept is not so limited, e.g., the elements of device 200 of FIG. 5 may be distributed in different units in any combination thereof. For example, receiver 205 of FIG. 5 may be a part of a device, or box, such as a set-top box that is physically separate from the device, or box, incorporating display 290, etc. Also, it should be noted that although described in the context of terrestrial broadcast (e.g., ATSC-DTV), the principles of the invention are applicable to other types of communications systems, e.g., satellite, Wi-Fi, cellular, etc. Indeed, even though the inventive concept was illustrated in the context of mobile receivers, the inventive concept is also applicable to stationary receivers. It is therefore to be understood that numerous modifications may be made to the illustrative embodiments and that other arrangements may be devised without departing from the spirit and scope of the present invention as defined by the appended claims.

1. A method comprising:
receiving a channel comprising at least one encoded stream and an error correcting stream, wherein the encoded stream is staggered with respect to the error correcting stream;
decoding the received encoded stream for providing content; wherein the decoding step includes correcting the received encoded stream using the received error correcting stream upon detecting errors in the received encoded stream; and
when a different channel is selected, decoding a received encoded stream of the different channel for providing content even though for an initial period of time equal to a time delay errors in the received encoded stream of the different channel are not correctable by the received error correcting stream of the different channel;
wherein the encoded stream of the different channel is delayed with respect to the error correcting stream of the different channel by the time delay.

2. The method of claim 1, wherein the time delay is variable.

3. The method of claim 1, wherein the error correcting stream is a Forward Error Correction code.

4. The method of claim 1, wherein the encoded signal is a scalable video code encoded signal having a base layer and at least one enhancement layer and wherein the error correcting stream only protects the base layer of the encoded signal.

5. The method of claim 1, wherein the encoded signal is a scalable audio code encoded signal having a base layer and at least one enhancement layer and wherein the error correcting stream only protects the base layer of the encoded signal.

6. A method comprising
receiving an encoded stream for conveying content;
generating an error correcting stream from the encoded stream for protecting the encoded stream against errors;
delaying the receiving encoded stream by a time delay;
forming a StaggerCast stream for transmission to a receiver, the StaggerCast stream comprising the delayed encoded stream and the error correcting stream for use in the receiver for performing fast channel change by decoding the delayed encoded stream even if data from the error correcting stream is not available for use when changing channels.

7. The method of claim 6, wherein the error correcting stream is a Forward Error Correction code.

8. The method of claim 6, wherein the time delay is variable.

9. The method of claim 6, wherein the encoded stream is a scalable video code encoded signal having a base layer and at least one enhancement layer and wherein the generating step generates the error correcting stream such that the error correcting stream only protects the base layer of the encoded signal.

10. The method of claim 6, wherein the encoded stream is a scalable audio code encoded signal having a base layer and at least one enhancement layer and wherein the generating step generates the error correcting stream such that the error correcting stream only protects the base layer of the encoded signal.

11. Apparatus comprising:
a demodulator for providing a demodulated signal, wherein the demodulated signal represents a StaggerCast signal having a StaggerCasting time delay;
a demultiplexer for forming from the demodulated signal an encoded stream and an error correcting stream, wherein the encoded stream is delayed with respect to the error correcting stream by the StaggerCasting time delay;
and
an error correction decoder for using data derived from the error correcting stream for correcting errors in the encoded stream such that upon a channel change the error correction decoder does not correct for errors for a period of time equal to the StaggerCasting time delay.

12. The apparatus of claim 11, wherein the error correcting decoder is a Forward Error Correction decoder.

13. The apparatus of claim 11, further comprising a delay buffer for delaying the error correcting stream by a time delay equal to the StaggerCasting time delay for providing a delayed error correcting stream to the error correction decoder.

14. The apparatus of claim 11, wherein the encoded stream represents a scalable video code encoded signal having a base layer and at least one enhancement layer and wherein the error correcting decoder only protects the base layer of the encoded stream.

15. The apparatus of claim 11, wherein the encoded stream represents a scalable audio code encoded signal having a base layer and at least one enhancement layer and wherein the error correcting decoder only protects the base layer of the encoded stream.

16. Apparatus comprising
a delay buffer for delaying an encoded stream, wherein the encoded stream conveys content;
an error correction encoder for generating an error correcting stream from the encoded stream for protecting the encoded stream against errors;
a multiplexer for multiplexing the error correcting stream and the delayed encoded stream for forming a StaggerCast stream for transmission to a receiver, the StaggerCast stream comprising the delayed encoded stream and the error correcting stream for use in the receiver for performing fast channel change by decoding the delayed encoded stream even if data from the error correcting stream is not available for use when changing channels.

17. The apparatus of claim 16, wherein the error correcting stream is a Forward Error Correction code.

18. The apparatus of claim 16, wherein the delay buffer implements a variable time delay.

19. The apparatus of claim 16, wherein the encoded stream is a scalable video code encoded signal having a base layer and at least one enhancement layer and wherein the error correction encoder generates the error correcting stream such that the error correcting stream only protects the base layer of the encoded signal.

20. The apparatus of claim 16, wherein the encoded stream is a scalable audio code encoded signal having a base layer and at least one enhancement layer and wherein the error correction encoder generates the error correcting stream such that the error correcting stream only protects the base layer of the encoded signal.
